(19) United States
(12) Patent Application Publication
(10) Pub. No.: US 2012/0314996 A1
(43) Pub. Date: Dec. 13, 2012

(54) OPTICAL FIBER COMMUNICATION APPARATUS

(75) Inventors: TAI-CHERNG YU, Tu-Cheng (TW); I-THUN LIN, Tu-Cheng (TW)

(73) Assignee: HON HAI PRECISION INDUSTRY CO., LTD., Tu-Cheng (TW)

(21) Appl. No.: 13/176,756

(22) Filed: Jul. 6, 2011

(30) Foreign Application Priority Data
Jun. 8, 2011 (TW) 100120059

(51) Int. Cl. G02B 6/32

(52) U.S. Cl. 385/33

(57) ABSTRACT

An optical fiber communication apparatus includes a laser diode, a light guiding member, and an optical fiber. The laser diode emits a laser beam along a first direction. The light guiding member includes a first aspheric converging lens portion and a reflecting surface. The converging lens portion is optically aligned with the laser diode, and converges the laser beam. The reflecting surface obliquely oriented at θ degrees relative to the first direction, and the θ degrees rendering the converged laser beam totally internal reflecting toward. The index of the light guiding member is in a rang from 1.415 to 1.5 or from 1.65 to 1.7, and 37.32° θ<45° or 45°<θ56.3°. The optical fiber is oriented along a second direction receives the reflected converged laser beam, and the second direction substantially perpendicular to the first direction.

### BACKGROUND

1. Technical Field

The present disclosure relates to communication technology, especially relating to an optical communication apparatus with one or more optical fibers.

2. Description of Related Art

Optical communication apparatus often use LED(s) as a light source. The light emitted by the LED is directed to one or more optical fibers. If an optical fiber is located along the direction of the light propagation, the optical communication apparatus will be bulky. If the optical fiber is bent to receive the light, it may be compact but light loss is added to the communication.

What is needed, therefore, is a compact optical fiber that will overcome the afore mentioned shortcomings.

### BRIEF DESCRIPTION OF THE DRAWINGS

Many aspects of the present optical fiber communication apparatus can be better understood with reference to the following drawings. The components in the drawings are not necessarily drawn to scale, the emphasis instead being placed upon clearly illustrating the principles of the present optical fiber communication apparatus. Moreover, in the drawings, like reference numerals designate corresponding parts throughout the views.

FIG. 1 shows a schematic view of an optical fiber communication apparatus in accordance with an exemplary embodiment.

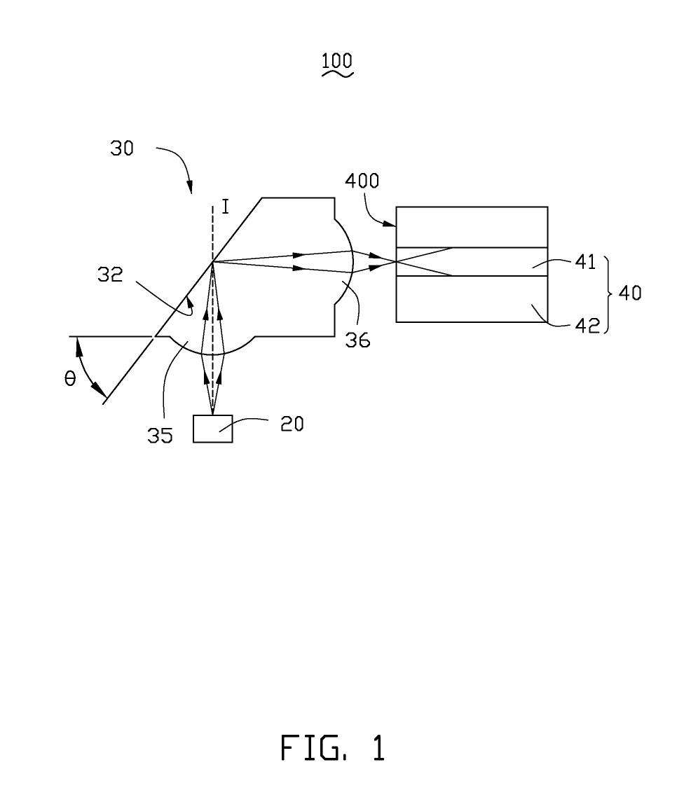

FIG. 2 is a diagram shows the relationship between acceptable angel a and a distance D between a light receiving end surface of an optical fiber and a reflecting surface, when the size of the end surface is constant.

### DETAILED DESCRIPTION

Referring to the drawing, an optical fiber communication apparatus 100 includes a laser diode 20, a light guiding member 30, and an optical fiber 40. In this embodiment, the laser diode 20 is a vertical cavity surface emitting laser (VCSEL). The laser diode 20 is mounted on a PCB (not shown).

A laser beam emitted from the laser diode 20 is transmitted substantially along a first direction.

The light guiding member 30 is a light guide block that includes a first aspheric converging lens portion 35, an inner reflecting surface 32, and a second aspheric converging lens portion 36. The first aspheric converging lens portion 35 is optically aligned with the laser diode 20 and configured for converging the laser beam. The first aspheric converging lens portion 35 includes a non-spherical surface that has a main optical axis I along the first direction. The first aspheric converging lens portion 35 is a flat-convex lens.

The inner slanted reflecting surface 32 is located inside the light refracting member 30 and obliquely oriented at an angle with θ degrees relative to the first direction. The angle renders the laser beam to be internally reflected toward the second aspheric converging lens portion 36 by the reflecting surface 32. The laser beam finally emits from the second aspheric converging lens portion 36.

When the light guiding member 30 is made of Polyetherimide (PEI), the index of the light guiding member is in a range from 1.65 to 1.7. According to experiments, when the index is 1.65, to gain a total internal reflection in the light guiding member 30, θ is about 37.34°. When the index is 1.7, the corresponding θ is about 37.32°. When the light guiding member 30 is made of Silicon (Si), the index of the light guiding member is in a range from 1.415 to 1.5. According to experiments, when the index is 1.415, to gain a total internal reflection in the light guiding member 30, θ is about just smaller than 45°. When the index is 1.5, the corresponding θ is about 41.85°.

The optical fiber 40 is oriented along a second direction, and configured for receiving the reflected converged laser beam. The second direction is substantially perpendicular to the first direction. The optical fiber 40 includes a transparent core 41 surrounded by a transparent cladding material layer 42 with a lower index of refraction than the core. The optical fiber 40 faces the second aspheric converging lens portion 36 and receives the maximum amount of the output laser beam. The optical fiber 40 includes a light receiving end surface 400. The distance between the end surface 400 and the reflecting surface 32 in the light path along the second direction is D.

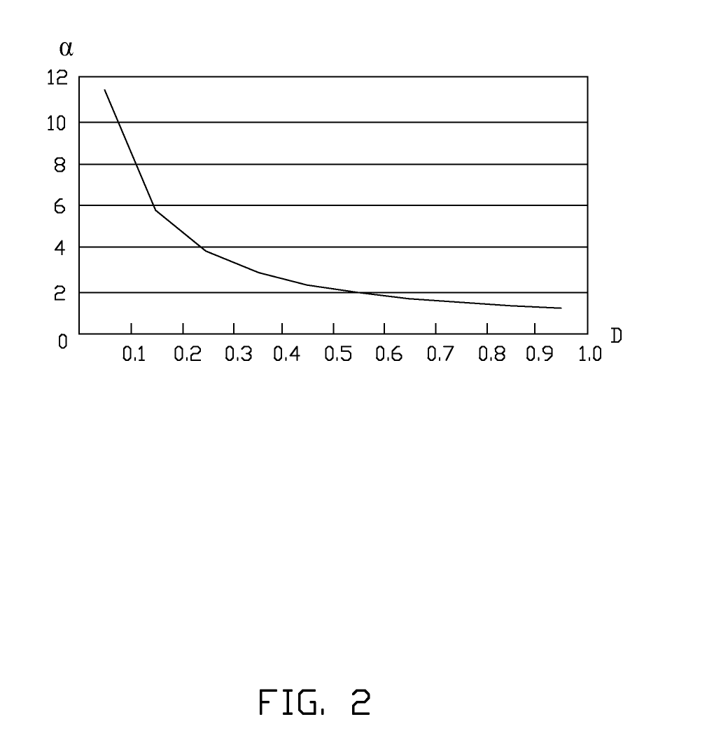

Referring to FIG. 2, when the size of the end surface is constant, D increases as an acceptable angle α for gaining a total internal reflection decreases. Commonly, the size of the end surface of a fiber is about 20 μm. For example, when D is about 0.1 mm, the maximum acceptable angle α is about 10 degrees. When D is in the range from 0.2 mm to 0.3 mm, the maximum acceptable angle α is about 4 degrees. Therefore, 0.1 mm D 1 mm, and it is preferred that 0.1 mm D 0.3 mm.

According to experiments and calculations, when the size of the end surface 400 and the value of D is assured, the maximum acceptable angle α is about 11.3 degrees. Take 45 degrees as the critical angle, the high limit is about 56.3°, that is, 45°<θ 56.3°, and the low limit is about 33.7°. However, 33.7° is smaller than the critical angle 37.32° when the index is the maximum value 1.7. Therefore, another range for θ is 37.32° θ<45°.

Take the maximum acceptable angle α is about 11.3 degrees as an example, when the refractive index of the light guiding member is in a range from 1.415 to 1.5, then 53.15° θ<56.3°. When the refractive index of the light guiding member is in a range from 1.65 to 1.7, then 48.64° θ 48.62°.

The second aspheric converging portion lens 36 is located between the reflecting surface 32 and the optical fiber 40. The second aspheric converging portion lens portion 36 is optically aligned with the second direction, i.e., a main optical axis of the second aspheric converging portion lens 36 is along with the second direction. The second aspheric converging portion lens portion 36 is configured for converging the reflected laser beam. The second aspheric converging lens portion 36 is a flat-convex lens.

In this embodiment, the first and second aspheric converging lens portion 35, 36 are both formed on the light guiding member 30 as a unitary body. The first aspheric converging lens portion 35 and the light guiding member 30 are comprised of a same material, and the second aspheric converging lens portion 36 and the light guiding member 30 are also comprised of a same material.

The reflecting surface 32 opposes the second aspheric converging lens portion 36. The first aspheric converging lens portion 35 is located under a bottom of the light guiding member 30 and interconnects the reflecting surface 32 and the second aspheric converging lens portion 36. The laser diode 20 is located beneath the first aspheric converging lens portion 35.

The light guiding member 30 redirects the direction of the laser beam into the optical fiber 40 located along the propagation of the output laser, thus a compact optical communication apparatus is obtained. The slanted reflecting surface 32 is obliquely oriented at specific angles with specific indexes. The laser beam is total internally reflected by the reflecting surface 32 without emitting from the reflecting surface 32, thus low light loss is gained.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. An optical fiber communication apparatus, comprising:
a laser diode for emitting a laser beam along a first direction;
a light guiding member comprising a first aspheric converging lens portion and a reflecting surface, the converging lens portion optically aligned with the laser diode and configured for converging the laser beam, the reflecting surface obliquely oriented at an angle relative to the first direction and configured for reflecting the converged laser beam, the refractive index of the light guiding member is in a range from 1.415 to 1.7; and
an optical fiber oriented along a second direction configured for receiving the reflected converged laser beam, the second direction substantially perpendicular to the first direction, the angle being in a range greater than or equal to 37.32° and strictly less than 45°, or strictly larger than 45° and less than or equal to 56.3° so as to enable the reflecting surface to totally internally reflecting the converged laser beam.

2. The optical fiber communication apparatus according to the claim 1, wherein the optical fiber comprises a light receiving end surface, a distance between the end surface and the reflecting surface in the light path along the second direction is in a range from 0.1 mm to 1 mm.

3. The optical fiber communication apparatus according to the claim 2, wherein the distance between the end surface and the reflecting surface in the light path along the second direction is in the range from 0.1 mm to 0.3 mm.

4. The optical fiber communication apparatus according to claim 1, wherein the first aspheric converging lens portion is integrally formed with the light guiding member.

5. The optical fiber communication apparatus according to claim 1, wherein the first aspheric converging lens portion and the light guiding member are comprised of a same material.

6. The optical fiber communication apparatus according to the claim 1, further comprising a second aspheric converging lens portion located between the reflecting surface and the optical fiber, the second aspheric converging lens portion optically aligned with the optical fiber, and configured for converging the reflected laser beam.

7. The optical fiber communication apparatus according to the claim 6, wherein an optical axis of the first aspheric converging lens portion is perpendicular to an optical axis of the second aspheric converging lens portion.

8. The optical fiber communication apparatus according to claim 7, wherein the second aspheric converging lens portion is integrally formed with the light guiding member.

9. The optical fiber communication apparatus according to the claim 7, wherein the second aspheric converging lens portion and the light guiding member are comprised of a same material.

10. The optical fiber communication apparatus according to the claim 1, the refractive index of the light guiding member is in a range from 1.415 to 1.5, and the angle being in a range greater than or equal to 53.15° and strictly less than 56.3° so as to enable the reflecting surface to totally internally reflecting the converged laser beam.

11. The optical fiber communication apparatus according to the claim 1, the refractive index of the light guiding member is in a range from 1.65 to 1.7; and the angle being in a range from 48.62° to 48.64° so as to enable the reflecting surface to totally internally reflecting the converged laser beam.
